(19) United States
(12) Patent Application Publication
(10) Pub. No.: US 2008/0237362 A1
(43) Pub. Date: Oct. 2, 2008

(54) Hot water supply system

(76) Inventor: Rui-Zong Huang, Taichung (TW)

Correspondence Address: RUI-ZONG HUANG, 235 Chung-Ho, Box 8-24, Taipei, TW

(21) Appl. No.: 11/728,295

(22) Filed: Mar. 26, 2007

(51) Int. Cl. G05D 23/32; G05D 23/02

(52) U.S. Cl. 236/93 R; 236/12.12

(57) ABSTRACT

A hot water supply system is provided for saving of water and energy. The disclosed subject matter implements a circle piping whereby the water flow in the circle piping can be promptly heated to the preset water temperature for use, so that the user does not need to wait for water to be heated and the objective of convenient use can be achieved. Similarly, the disadvantage of draining a great quantity of cold water before the desired hot water is produced in a conventional hot water system can also be solved.

### BACKGROUND OF THE INVENTION

1. Technical Field

The present invention relates to a hot water supply system and, more particularly, to a hot water supply system capable of preheating the water flow in the water supply pipe thereof and monitoring the water temperature.

2. Description of Related Art

Water heaters are known for providing warm water for washing and bathing and have become indispensable to every modern family. Some popular types of water heaters are, for example, gas water heaters, electric water heaters and solar water heaters. Among these types of water heaters, gas water heaters are generally used in ordinary families due to the steady operation thereof as well as the relative low equipment and energy costs. A gas water heater typically heats water by means of burning natural gas. However, burning natural gas can undesirably consume considerable quantities of oxygen and produce carbon dioxide. More seriously, incomplete combustion of gas may induce toxic gases, such as carbon monoxide. Thus, accidents of asphyxia due to oxygen deficiency or carbon monoxide poisoning caused by using gas water heaters indoors are reported from time to time. Besides, in case of improper operation or pipe breakage, gas may leak and pervade in the interior space of a house. At this time, lighting fire or electric sparks can easily bring about explosions or conflagrations. Particularly, in wintertime or rainy seasons, people usually close doors and windows, and foresaid accidents are even more likely to happen in such airless environments. Thus, it is obvious that installing a gas water heater indoors is very dangerous. Hence, people may install gas water heaters outdoors or at a veranda, where ventilation is better, in order to avoid foresaid accidents. Accordingly, as the distance between the water heater and the water faucet significantly increases from meters to dozen meters or even longer, temperature difference may occur between water in the front part and in the rear part of the pipe; as a result, it is difficult to maintain a constant temperature for the supply of hot water. Moreover, a great quantity of water is wasted at the initial stage of water supply and this also causes inconvenience. For example, in the initial stage of hot water supply, when a user turns on the water faucet, he may have to wait for 10 or 20 seconds for the water heater to burn gas for heating water and for the water to be heated to a desired temperature. Therefore such a gas water heater is inconvenient to use. Also, during the said waiting time, all the cold water in the water supply pipe is discharged. The quantity of the discharged water can be more than 5 liters for each time according to a conservative estimate. That is to say, every person can waste more that 1,500 liters of water every year and for all the population in Taiwan, that is at least 35 billion liters of water wasted per year. Consequently, this not only increases the water bill to every individual, but also exhausts the limited water resources. The above defects may be remedied by using a hot water boiler or a high-power electric water heater. However, a hot water boiler is expensive and an ordinary family may be not able to afford one; while a high-power electric water heater consumes considerable sum of power and requires rearrangement of the power supply device to meet the current demand thereof. Thus, both strategies cannot remedy the aforesaid problems effectively.

### SUMMARY OF THE INVENTION

The present invention has been accomplished under these circumstances in view. It is one objective of the present invention to provide a hot water supply system that facilitates saving water and energy and is convenient to use. The disclosed subject matter implements a novel design of the circle piping, whereby the water flow in the circle piping can be promptly heated to the preset water temperature for use, so that the user does not needs to wait for water to be heated and the objective of convenient use can be achieved. Similarly, the disadvantage of draining a great quantity of cold water before the desired hot water is produced in a conventional hot water system can also be solved.

It is another objective of the present invention to provide a hot water supply system that has a control unit for monitoring the water temperature inside the circle piping by means of a plurality of water temperature sensors installed in the piping, and for adjusting the water heating operation of the hot water source accordingly. Thereby, the defect of fluctuations in the temperature of the water supply can be eliminated and the danger of scalding by excessively hot water can be prevented.

It is still another objective of the present invention to provide a hot water supply system that ensures a user's safe use. The design of the circle piping permits the hot water source to remotely operate outdoors or at a safe place, while promptly deliver the hot water at a constant temperature indoors for use. Thus, even if the hot water supply is a gas water heater, the user in the house can be free from the danger of oxygen deficiency or toxic gas-poisoning.

It is yet another objective of the present invention to provide a hot water supply system that is easy to be operated. As a plurality of user control units are provided at the places where water faucets or water outlet devices are arranged or at places where water temperature monitoring is required, the user can use the user control units to start preheating operation, to set water supply temperature, to observe the water temperature condition for determining when to start to use the hot water and to pre-schedule heating operation for meeting his usage preference.

### BRIEF DESCRIPTION OF THE DRAWINGS

The invention as well as a preferred mode of use, further objectives and advantages thereof, will be best understood by reference to the following detailed description of an illustrative embodiment when read in conjunction with the accompanying drawings, wherein:

FIG. 1 is a schematic drawing showing the structure of the disclosed subject matter; and

FIG. 2 is a functional block diagram of the present invention.

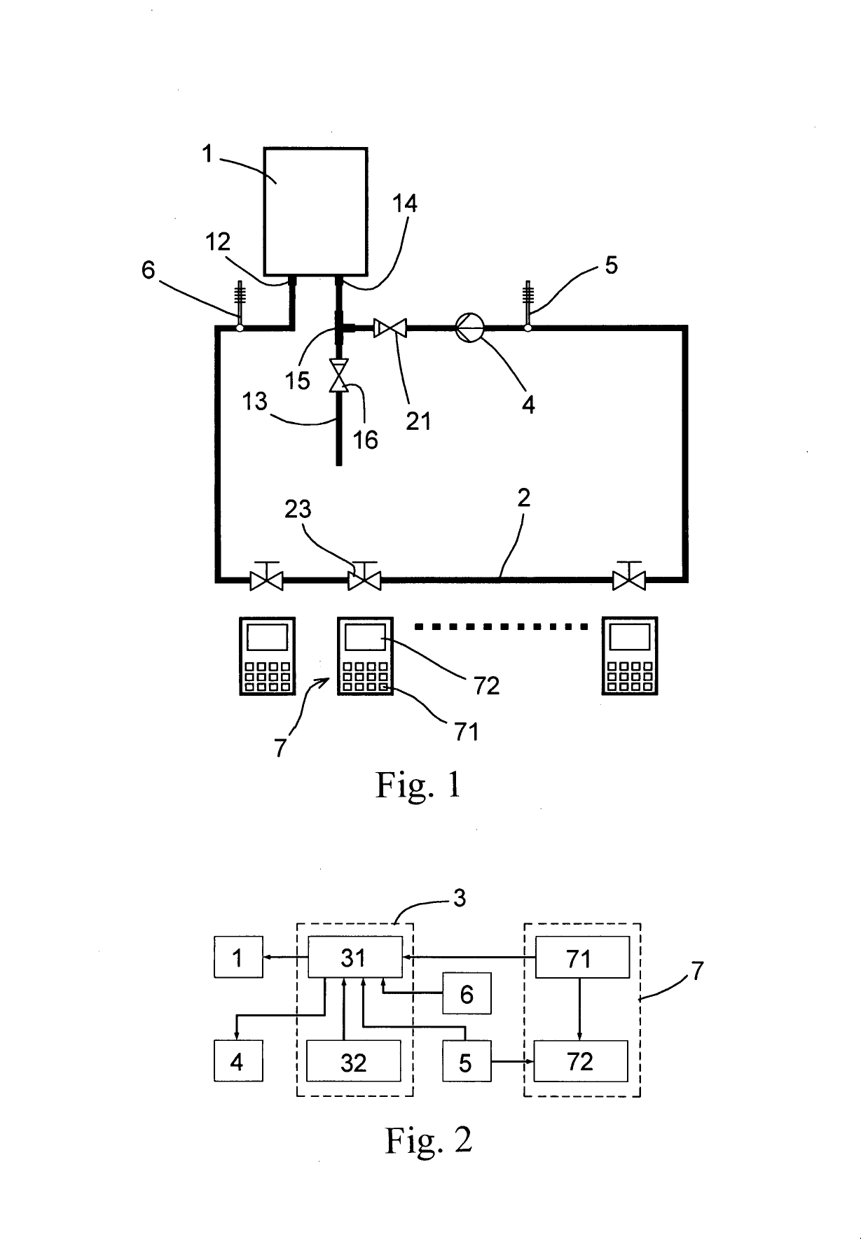

### DETAILED DESCRIPTION OF THE PREFERRED EMBODIMENT

The hot water supply system of the embodiment is shown in the accompanying drawings and primarily comprises a hot water source 1, a circle piping 2, a control unit 3, a pump 4, a first temperature sensor 5, a second temperature sensor 6 and a plurality sets of user control units 7.

According to the present embodiment, the hot water source 1 can be a gas-operated water heater installed outdoors. A cold water inlet 12 of the water heater is connected to a cold water pipe 13 equipped with a one-way valve 16. Thereby, the water flow input from the cold water pipe 13 can be heated by a heating unit (not shown in the drawings) of the water heater and then be outputted from a water outlet 14 of the water heater.

The front end of the circle piping 2 is connected with the hot water outlet 14 of the water heater while the rear end thereof is equipped with a one-way valve 21, and is connected with a T-pipe 15 settled on the cold water pipe 13. Upon such arrangement, the hot water source 1 and the circle piping 2 jointly form a one-way water flow cycle system. The one-way valve 21 is provided for preventing the cold water in the cold water pipe 13 from flowing back to the circle piping 2 during the operation of the hot water supply. Further, the circle piping 2 is provided for delivering the hot water produced by the hot water source 1 into the interior of the house (a bathroom) for use. One or more water faucets 23 may be arranged on the circle piping 2 for leading out the hot water for use.

The control unit 3 comprises a temperature control section 31 and a pre-scheduling section 32. The temperature control section 31 functions for monitoring the temperature of the water flow in the circle piping 2, and for maintaining the water temperature in accordance with the desired temperature preset by a user. The pre-scheduling section 32 directs the temperature control section 31 to operate for a period of time at some preset time points or with preset periodic intervals.

The pump 4 is deposited at the rear part of the circle piping 2 and is operated by the temperature control section 31 of the control unit 3. When the pump 4 is operated, it can pump the water flow inside the circle piping 2 to pass the one-way valve 21 and enter the cold water pipe 13.

The first temperature sensor 5 is installed at the end part of the circle piping 2 for detecting the temperature of the water flow in the end part of the circle piping 2. If the first temperature sensor 5 detects that the actual water temperature inside the circle piping 2 is lower than the preset water temperature, the temperature control section 31 of the control unit 3 shall start the pump 4 to operate, so as to guide the water flow inside the circle piping 2 to pass through the one-way valve 21 and enter the cold water pipe 13 to be sent into the water heater for reheating. Meantime, the fresh hot water is inputted into the circle piping 2 from the water outlet 14 of the water heater until the actual water temperature inside the circle piping 2 detected by the first temperature sensor 5 equals to the preset water temperature. Then the temperature control section 31 stops the operation of the pump 4. Thereby, the water flow in the circle piping 2 can be promptly heated to the preset water temperature for use.

The second temperature sensor 6 is provided at the front part of the circle piping 2 for detecting the temperature of the hot water that flows from the water outlet 14 of the water heater, so that the temperature control section 31 of the control unit 3 can adjust the heating operation of the hot water source 1 accordingly, in order to feed the circle piping 2 with the hot water conforming to the preset water temperature.

Each of the user control units 7 may have a control panel 71 for controlling the temperature control section 31 of the control unit 3 to start or stop, thus allowing a user to set a desired hot water temperature. Further, each of the user control units 7 may have a water-temperature display device 72, such as a liquid crystal display (LCD), which displays the temperature of the hot water in the circle piping 2 to a user for his reference. Moreover, the water-temperature display device 72 can be equipped with an alarm that functions for giving different types of sound or lamplight to indicate different water temperatures. For instance, when the water temperature is equal to the set temperature, a green light illuminates; when the water temperature is lower than the set temperature, a yellow light illuminates; and when the water temperature is higher than the set temperature (or as high as a warning temperature), a red light illuminates. Thereby, the user can be indicated or warned of the status of the water temperature, so that the user's safety with regard to using hot water can be ensured. Additionally, each said user control unit 7 can be installed at any place where a water faucet or a water outlet device is provided, or at any place where the water temperature monitoring is required to facilitate convenient use and safety with using hot water.

While the present invention is composed of foresaid components, the technical features and functions may be further expounded through the following three operation modes.

### Operation Mode 1: Immediate Hot Water Supply

When a user intends to use hot water at a non-specific time point (i.e. immediately), he may operate the control panel 71 of the user control unit 7 to start the operation of the temperature control section 31 of the control unit 3. During the operation of the temperature control section 31, when the first temperature sensor 5 detects that the actual water temperature inside the circle piping 2 is lower than the preset water temperature, it starts the pump 4 to pump the cold water inside the circle piping 2 into the cold water pipe 13. Through the one-way valve 16 installed in the cold water pipe 13, the water flowing into the cold water pipe 13 from the circle piping 2 can be transported to the water heater for reheating. Meantime, the newly produced hot water is led into the circle piping 2 from the water outlet 14 of the water heater, so that the temperature of the water flow in the circle piping 2 can rise up to meet the preset water temperature for use. During the above procedure, the user can observe the water temperature status inside the circle piping 2 through the water-temperature display device 72 of the user control unit 7, thereby determining when to start to use the hot water. In the foregoing preheating operation, since there is not much water in the circle piping 2, the system can promptly make the water temperature inside the circle piping 2 rise to meet the preset water temperature. Thus, the disclosed subject matter permits the user to obtain regular hot water supply conveniently and promptly without spending time for waiting. Also, by the disclosed subject matter, the disadvantage of draining a great quantity of cold water before the desired hot water is produced in a conventional hot water system can also be solved. On the other hand, the disclosed hot water supply system is different from the conventional heat-water boilers systems because it does not require continuous heating to maintain a particular temperature when not in use, so the cost of energy can be significantly reduced. Further, the hot water supply system of the present invention can completely eliminate the safety problems, which are resulted from high temperature and high pressure of the conventional heat-water boilers systems.

### Operation Mode 2: Pre-Scheduling Started Hot Water Supply

When the scheduled time point set by the user through the pre-scheduling section 32 of the control unit 3 is due, the temperature control section 31 of the control unit 3 shall automatically start and operate for a period of time. During the operation of the temperature control section 31, when the first temperature sensor 5 detects that the actual water temperature inside the circle piping 2 is lower than the preset water temperature, it starts the pump 4 to pump the relative cold water inside the circle piping 2 into the cold water pipe 13. The relative cold water is then transported to the water heater for reheating. Meantime, the newly produced hot water is led into the circle piping 2 from the water outlet 14 of the water heater, so that the temperature of the water flow in the circle piping 2 can be maintained at the preset water temperature. Thus, the user is allowed to use hot water conveniently anytime during the pre-scheduled heating operation. Since there is not much water in the circle piping 2, and a thermal insulating layer may be provided to enclose the circle piping 2 to slow down heat loss, the system requires only significantly less energy cost for maintaining the water temperature inside the circle piping 2 at a desirable level during the said preheating operation.

Operation Mode 3: Constant Temperature Hot Water Supply during Hot Water Supply Operation

When the hot water in the circle piping 2 is led out for use from the water faucet 23 continuously, the hot water source 1 keeps delivering hot water into the circle piping 2 by way of the water outlet 14 thereof. At the same time of the hot water supply operation; the temperature control section 31 of the control unit 3 keeps monitoring the temperature of the hot water led into the circle piping 2 by means of the second temperature sensor 6 arranged at the front part of the circle piping 2. When it is detected that the water fed from the water outlet 14 is hotter than the preset water temperature, the temperature control section 31 can instantly decrease the heating to the hot water conducted by the hot water source 1. Whereas if the water fed from the water outlet 14 is colder than the preset water temperature, the temperature control section 31 can increase the heating to the hot water conducted by the hot water source 1, so as to ensure that the hot water delivered into the circle piping 2 by the hot water source 1 conforms to the preset water temperature. Thereby, the user can be supplied with the hot water at a constant temperature, so that the defect of fluctuating temperature of water supply can be eliminated and the danger of scalding by excessively hot water can be prevented.

Although a particular embodiment of the invention has been described in details for purposes of illustration, it will be understood by one of ordinary skill in the art that numerous variations will be possible to the disclosed embodiments without going outside the scope of the invention as disclosed in the claims.

What is claimed is:

1. A hot water supply system comprising
a hot water source capable of outputting heated water flow continuously and having a water inlet connected to a low-temperature water pipe and a water outlet, wherein a low-temperature water flow input from the water inlet can be heated by a heating unit of the hot water source and be outputted as hot water from the water outlet;
a circle piping connected to the water outlet of the hot water source at the front end thereof, while being connected to the low-temperature water pipe at the rear end thereof and having at least one outlet valve equipped thereon;
a control unit having at least one temperature control section and a pre-scheduling section, wherein the temperature control section functions for monitoring a temperature of the water flow in the circle piping and maintaining the water temperature in accordance with a preset predetermined temperature, and the pre-scheduling section directing the temperature control section to operate for a period of time at some preset time points or at periodic intervals;
a pump deposited in the circle piping and being controlled by the temperature control section of the control unit;
a temperature sensor installed at an end part of the circle piping for detecting the temperature of the water flow in the end part of the circle piping, and transmitting detected parameters about water temperature to the temperature control section of the control unit for computing; and
a plurality of user control units installed near a water faucet or a water outlet device being provided or at a position where the water temperature is monitored, each user control unit having at least a control panel and a water-temperature display device, wherein the control panel is provided for controlling the temperature control section of the control unit to start or stop, thus allowing a user to set a desired hot water supply temperature, while the water-temperature display device is provided for displaying the temperature of the hot water in the circle piping;
whereby the temperature control section is started through the operation of the control panel of the user control unit or the pre-scheduling setting programmed at the temperature control section of the control unit, and when the temperature control section detects that the actual water temperature inside the circle piping is lower than the preset water temperature by means of the temperature sensor, the pump is started to operate and guide the water flow inside the circle piping into the low-temperature water pipe for being transported into the hot water source and reheated and meantime, the fresh hot water is inputted into the circle piping from the water outlet of the water heater until the actual water temperature inside the circle piping detected by the temperature sensor is equal to the preset water temperature and then the temperature control section stops the operation of the pump.

2. The hot water supply system of claim 1, wherein the hot water source is capable of outputting the hot water at a predetermined temperature under the control of the control unit.

3. The hot water supply system of claim 2, wherein the predetermined temperature is changeable by varying the setting on the user control unit.

4. The hot water supply system of claim 1, further comprising a check valve settled at a rear end of the circle piping.

5. The hot water supply system of claim 1, wherein the water-temperature display device is a display capable of displaying temperature values.

6. The hot water supply system of claim 1, wherein the water-temperature display device is an alarm capable of giving different types of sounds or lamplight according to the conditions of water temperature.

7. A constant-temperature hot water supply system comprising
a hot water source capable of outputting heated water flow continuously, and having a water inlet connected to a low-temperature water pipe and a water outlet, wherein a low-temperature water flow inputted from the water inlet can be heated by a heating unit of the hot water source and be outputted as hot water from the water outlet;
a circle piping connected to the water outlet of the hot water source at the front end thereof, while being connected to the low-temperature water pipe at the rear end thereof and having at least one outlet valve equipped thereon;
a control unit having at least one temperature control section and a pre-scheduling section, wherein the temperature control section functions for monitoring the temperature of the water flow in the circle piping and maintaining the water temperature in accordance with a predetermined temperature, and the pre-scheduling section directed the temperature control section to operate for a period of time at a predetermined time points or with periodic time intervals;
a pump deposited in the circle piping and being controlled through the temperature control section of the control unit;
a first temperature sensor installed in the end part of the circle piping for detecting the temperature of the water flow in the end part of the circle piping, and transmitting detected parameters of water temperature to the temperature control section of the control unit for computing;
a second temperature sensor installed in the front part of the circle piping for detecting the temperature of the water outputted from the water outlet of the hot water source and transmitting the detected parameter of water temperature to the temperature control section of the control unit for computing; and
a plurality of user control units installed at a place near a water faucet or at a place where a water outlet device is provided or at a place where the water temperature monitoring is required, each control unit comprising at least a control panel and a water-temperature display device, wherein the control panel is provided for controlling the temperature control section of the control unit to start or stop, thus allowing a user to set a desired hot water supply temperature; while the water-temperature display device is provided for displaying the temperature of the hot water in the circle piping; whereby the temperature control section can be started through the operation of the control panel of the control unit or the pre-scheduling setting programmed at the temperature control section of the control unit, and when the temperature control section detects that the actual water temperature inside the circle piping is lower than the preset water temperature by means of the first temperature sensor, the pump is started to operate and guide the water flow inside the circle piping into the low-temperature water pipe for being transported into the hot water source and reheated and meantime, the newly produced hot water is inputted into the circle piping from the water outlet of the water heater until the actual water temperature inside the circle piping detected by the temperature sensor is equal to the preset water temperature, and then the temperature control section stops the operation of the pump; while the temperature control section also implements the second temperature sensor to detect the water temperature at the water outlet of the hot water source and adjusts the heating operation of the hot water source accordingly, in order to feed the circle piping with the hot water conforming to the preset water temperature for use.
